(19) United States
(12) Patent Application Publication
(10) Pub. No.: US 2004/0261622 A1
(43) Pub. Date: Dec. 30, 2004

(54) Porous denuder system

(75) Inventors: Tung-Sheng Shih, Taipei Hsien (TW); Chuen-Jinn Tsai, Hsinchu (TW); Cheng-Hsiung Huang, Hsinchu (TW)

Correspondence Address: BACON & THOMAS, PLLC, 625 SLATERS LANE, FOURTH FLOOR, ALEXANDRIA, VA, 22314

(73) Assignee: Institute of Occupational Safety and Health, Council of Labor Affairs, Executive, Taipei Hsien (TW)

(21) Appl. No.: 10/856,840

(22) Filed: Jun. 1, 2004

(30) Foreign Application Priority Data
Jun. 30, 2003 (TW) 92117899

(51) Int. Cl. B01D 46/00

(52) U.S. Cl. 96/413

(57) ABSTRACT

A porous denuder system includes: a sample inlet, which is a hollow tube and has a first connecting element at its top, external end; a particle sorter comprising one or a plurality of annular sorters, the sorter located in the sample inlet and one of its ends being pushing against an inside of the top end of the sample inlet; a porous collecting element being made of a porous material; and a sampling body which is a hollow tube and has a first connecting element at its external top end for connecting to the first connecting element at the sample inlet external top end, and a stopper at its bottom end for pushing against the porous absorbing element so the porous absorbing element is placed between the particle sorter and the stopper, and the stopper has a through hole or a through tube at its center for connecting to an external part.

### BACKGROUND OF THE INVENTION

1. Field of the Invention

The present invention relates to a porous denuder system.

2. Description of the Related Art

A honey-comb denuder system (HDS) uses a impactor to remove particulates having diameters greater than 2.5 μm from an inlet, and causes gas passing through two stages of the honey-comb denuder system, coated with different chemical materials, to be collected. The HDS has several advantages, such as an even gas flow, high adhesive efficiency and a large adhesive capacity, which reduces the sample gas loss amount. However, it also has some shortcomings, such as being difficult to manufacture, and extremely costly.

Furthermore, most prior art denuders can only be used for atmospheric samples, and is not good for industrial environments with high pollution concentrations.

Therefore, it is desirable to provide a porous denuder system to mitigate and/or obviate the aforementioned problems.

### SUMMARY OF THE INVENTION

A main objective of the present invention is to provide a porous denuder system.

Another objective of the present invention is to provide a porous denuder system, which contains a sample inlet, a particle sorter, a porous collecting element and a sampling body.

The porous denuder system comprises: a sample inlet, which is a hollow tube and has a first connecting element at its top, external end; a particle sorter comprising one or a plurality of annular sorters, the sorter located in the sample inlet and one of its ends being pushing against an inside of the top end of the sample inlet; a porous collecting element being made of a porous material; and a sampling body which is a hollow tube and has a first connecting element at its external top end for connecting to the first connecting element at the sample inlet external top end, and a stopper at its bottom end for pushing against the porous absorbing element so the porous absorbing element is placed between the particle sorter and the stopper, and the stopper has a through hole or a through tube at its center for connecting to an external part. The sample inlet and the sampling body are similar to sample inlets and sampling bodies in the prior art, and is used to form a housing to contain the particle sorter and the porous collecting element, and is connected to other elements, such as filter material element (a filter paper cartridge).

The first connecting element and the second connecting element can be any well known connecting element, and the prior art connecting element is a preferred choice.

The particle sorter comprises one or a plurality of annular sorters, with a plurality of concentric annular sorters being a better choice; two to six annular sorters being even better, and three to five annular sorters being preferred.

The particle sorter may be a well-known inertial impactor.

The porous collecting element may be any well known porous collecting material to form the denuder, and the prior art collecting material is preferred.

The external portion may be any other prior art sampler, such as a filter material element (a filter paper cartridge).

The porous denuder system of the present invention is a new type of denuder, which utilizes the particle sorter (such as an inertial impactor) to remove aerosols with aerodynamic diameters exceeding 2.5 μm, and then passing the gas through a porous metal sheet having a diameter of 4.7 cm, a thickness of 0.23 cm, a pore diameter of 100 μm for absorption by a chemically coated material. For example, a material chemically coated with 1% sodium carbonate/1% glycerol has a gas absorption efficiency of above 99% and 93% respectively for SO₂ and HNO₃. A gas absorption capacity is even larger for gasses with higher concentrations; for example, a material chemically coated with 2% sodium carbonate/1% glycerol has a gas absorption capacity of 8.4 mg for SO₂.

The present invention utilizes one or a plurality of levels (such as five levels) for the inertial impactor, which is mounted at a front end of the porous metal sheet and used for collecting acidic particles having different, larger diameters to prevent the particles being lost in the porous metal sheet and thereby affecting the accuracy of gas concentration measurements. In one experiment, first to fifth aerodynamic diameters were 9.5 μm, 6.7 μm, 4.8 μm, 3.2 μm and 2.0 μm, and a particulate loss amount was kept below 10%. Comparing the differences between a Teflon sheet and a porous metal sheet in an experiment, when oleic acid particles were used as the aerosol, no wash-off occurred on both of the two collecting sheets; but particulates on the porous metal sheet underwent pore absorption. Furthermore, over-loaded particulates on the Teflon sheet flush off with increasing time, but the particulates on the porous metal sheet are absorbed internally.

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of a porous denuder system of a first embodiment according to the present invention.

FIG. 2 is an exploded view of a filter element shown in FIG. 1.

FIG. 3 is an exploded view of a porous denuder system of a second embodiment according to the present invention.

FIGS. 4˜22 are experiment data charts according to the present invention.

### DETAILED DESCRIPTION OF THE PREFERRED EMBODIMENT

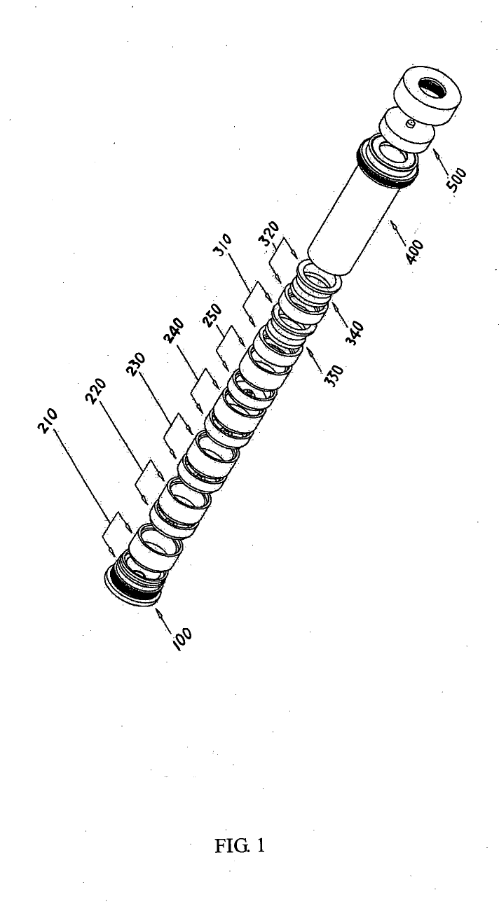

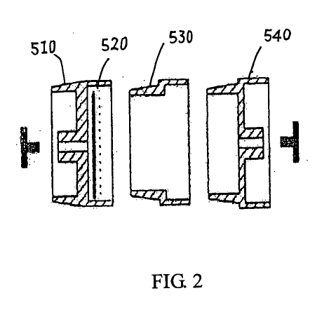

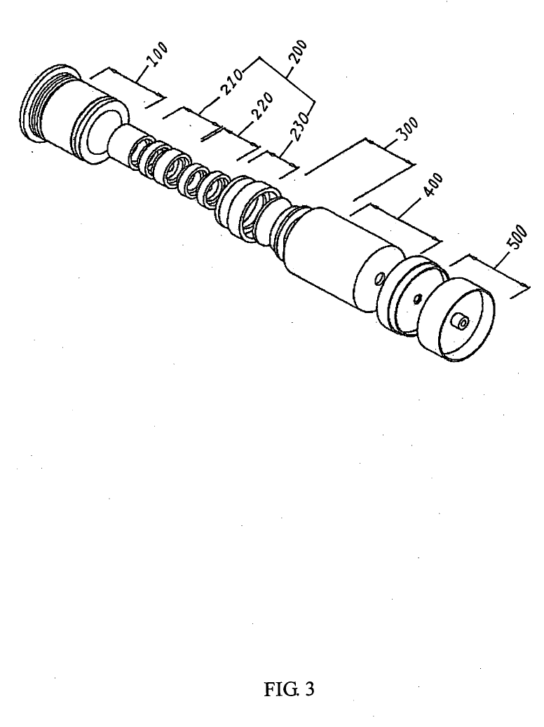

Please refer to FIG. 1. FIG. 1 is an exploded drawing of a porous denuder system of a first embodiment according to the present invention. In FIG. 1, the porous denuder system comprises: a sample inlet 100; a particle sorter 200, which comprises a first stage inertial impactor 210, a second stage inertial impactor 220, a third stage inertial impactor 230, a fourth stage inertial impactor 240 and a fifth stage inertial impactor 250; a porous collecting element 300, which comprises a first stage denuder 310, a second stage denuder 320 and two porous metal sheets 330, 340; a sampling body 400; a filter element 500, and an outlet 600. Please refer to FIG. 2. FIG. 2 is an exploded view of a filter element (filter paper cartridge) 500 shown in FIG. 1. The filter paper cartridge 500 comprises a bottom cover 510, a filter paper 520, a filter paper holder 530 and a top cover 540.

Please refer to FIG. 3. FIG. 3 is an exploded drawing of a porous denuder system of a second embodiment according to the present invention. In the second embodiment, the porous denuder system comprises: a sample inlet 100; a particle sorter 200, which comprises a first stage inertial impactor 210, a second stage inertial impactor 220, a third stage inertial impactor 230, a fourth stage inertial impactor 240 and a fifth stage inertial impactor 250; a porous collecting element 300, which comprises a first stage denuder 310, a second stage denuder 320 and two porous metal sheets 330, 340; a sampling body 400; and a filter element 500.

### Design of the Sample Inlet

According to the Witschger et al. formula, the present invention calculates an intake efficiency (E_{E}) as follows:

$$\begin{matrix}{E}_{E} = \frac{1}{1 + 2 {St}_{w}^{{k}_{1}} {R}^{{k}_{2}}} [ 1 + {{St}_{w}^{{k}_{3}} ( \frac{R ( \frac{Ds}{h} )}{{k}_{5}} )}^{{k}_{4}} ] & ( 1 ) \\ Wherein St = \frac{{ρ}_{p} {d}_{p}^{2} UwC}{9 μ Ds} & ( 2 ) \\ R = \frac{Uw}{Us} & ( 3 )\end{matrix}$$

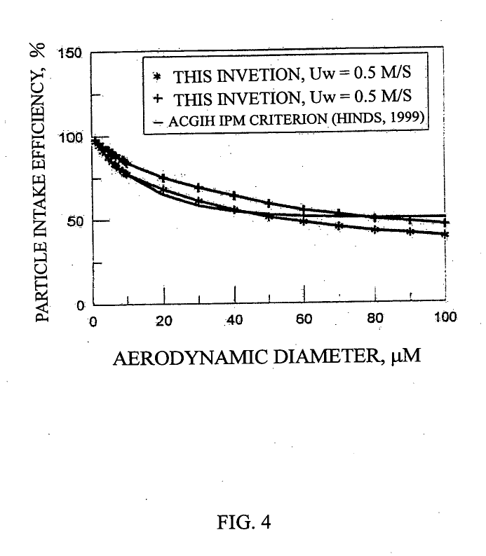

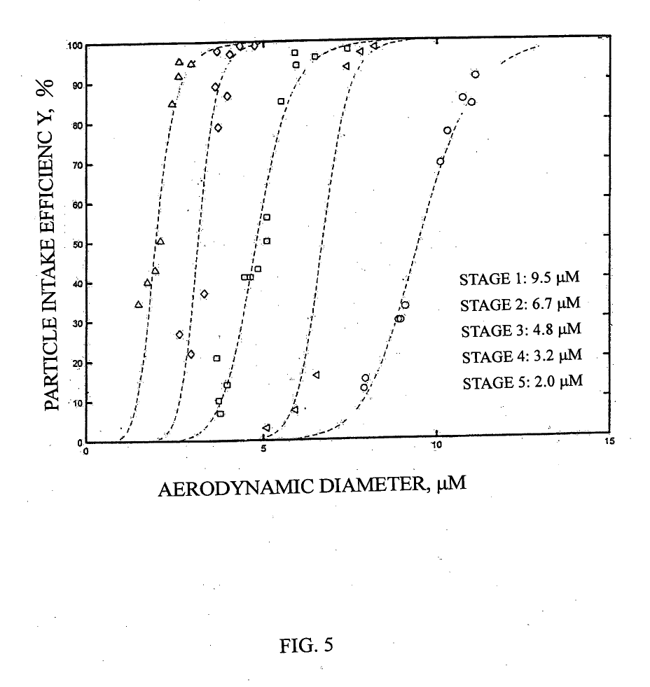

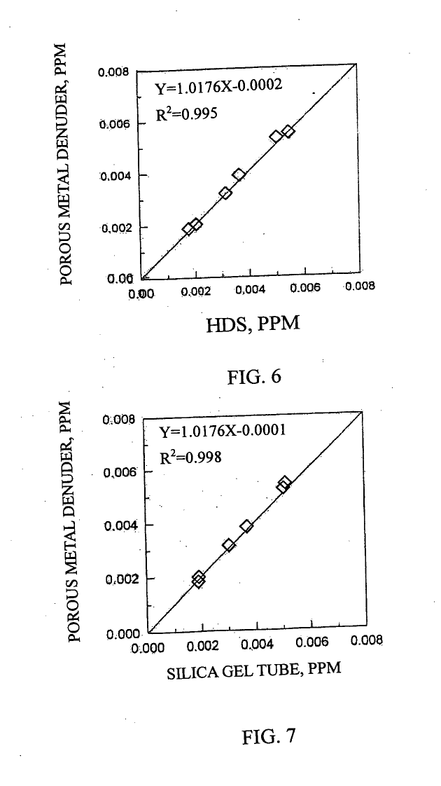

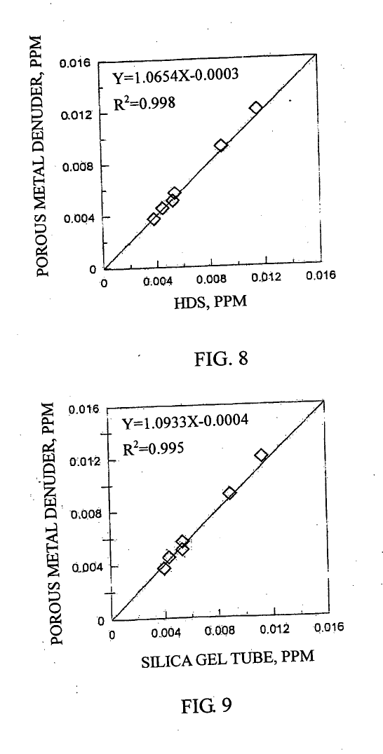

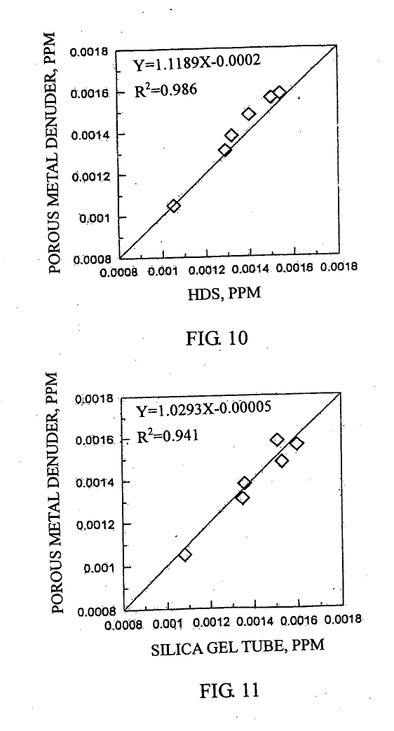

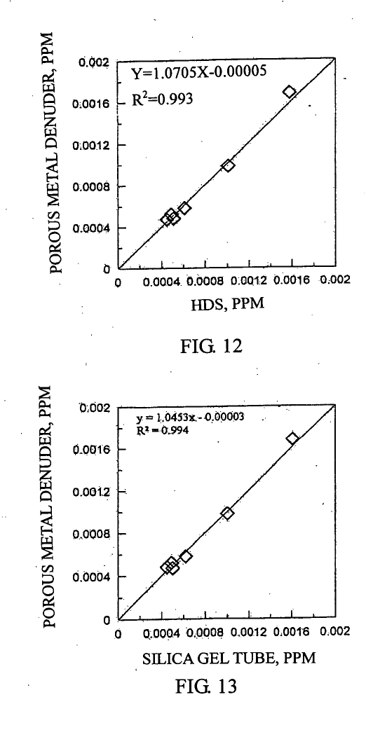

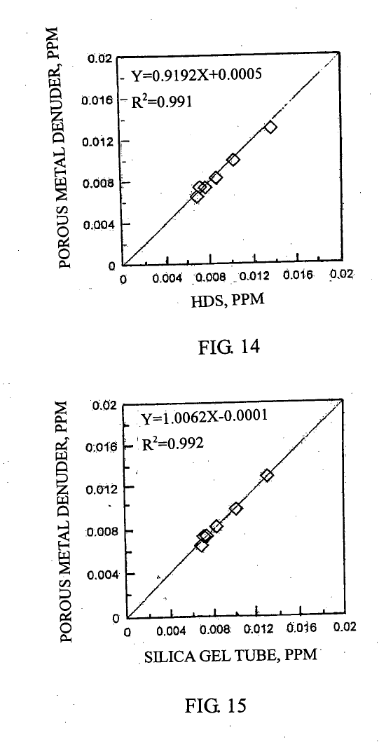

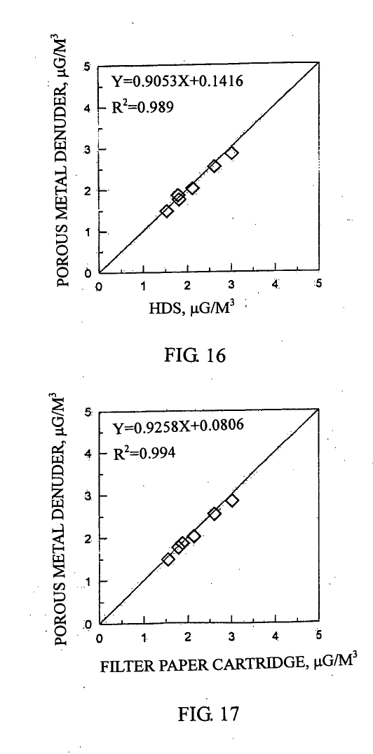

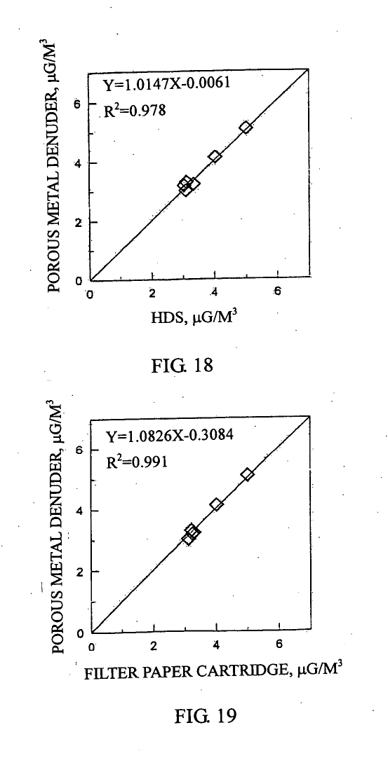

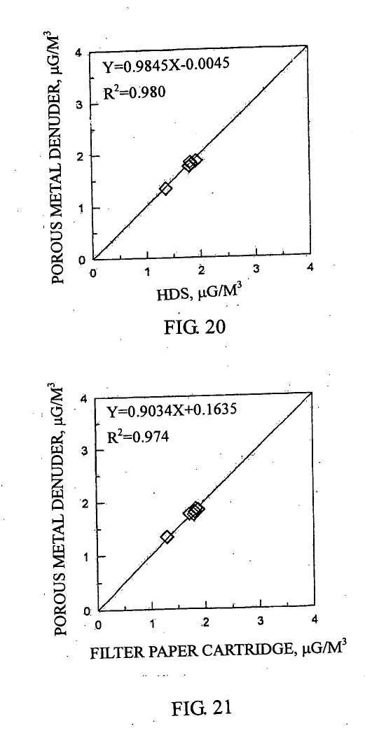

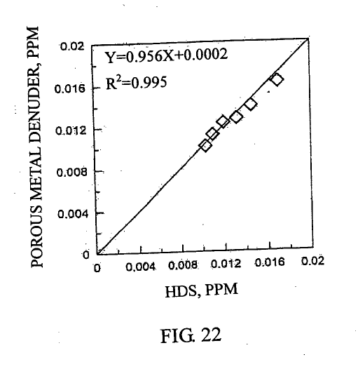

ρₚ is the particle density, dₚ is the particle diameter, Uw is an external wind speed; Usin an intake speed, C is a particle slippage correction factor, μ is a gas adhesive coefficient, Ds is the diameter of a circular cap, and h is a distance from the circular cap to the sampling body. To prevent larger particles from entering the sampling body due deposition effects, and in consideration of the particulate intake efficiency, a circular cap and four movable pins are utilized, which are easy to assemble, and the circular cap ensures aerosol sampling from all directions. According to formula (1), when Uw=1 m/s and 0.5 m/s, Ds=30 mm, h=1.5 mm, the sampling flow amount was 2 lpm, the particulate intake efficiency was obtained and compared to an intake particle standard of ACGIH, to obtain FIG. 4. In FIG. 4, when the aerodynamic diameters were 9.5 μm, 6.7 μm, 4.8 μm, 3.2 μm and 2.0 μm, the relative particle intake efficiencies were 85%, 90%, 92%, 94% and 96%. During analysis, the original data needed to be divided by different stage intake efficiencies to obtain the correct particle concentrations. After intake, the particles entered into the first stage inertial impactor of the sampling body. The sampling body had a nozzle with a diameter of 7.2 mm, an O-ring to avoid gas leakage, and an outer thread for screwing onto the sampling body. The sampling body was 136 mm long, and had an inner diameter of 30.6 mm, with an inner thread for screwing with the first stage nozzle at the inlet; each nozzle of each inertia impactor stage, and a jarring board, can be sequentially placed in the sampling body. The porous metal sheet, and the O-ring clamped behind the sampling body, utilized a plurality of screws to avoid gas leakage in the sampling body.

### Experimental Results for Particulate Collection Efficiency of the Inertia Jarring Machine, and Inner Wall Loss

The diameters of the multiple stage inertial impactor and nozzles of the 2-5 stage jarring boards were 4.8 mm, 3.6 mm, 2.6 mm, and 1.9 mm. All inertial impactors were made of Teflon, and had a sampling flow rate of 2 lpm. Every nozzle was connected to the jarring boards. The porous metal sheets were used as collecting boards. A diameter of the collecting board was 15 mm, and a diameter of the porous metal sheet was 12 mm. Based upon experimental results, the porous metal sheet and the inertial impactors prevent over-loaded particulates from being washed off. As shown in FIG. 5, the first to the fifth aerodynamic diameters were 9.5 μm, 6.7 μm, 4.8 μm, 3.2 μm and 2.0 μm, and the particulate loss amount was controlled to under 10%, with no over-loaded particulates.

The porous metal sheet had a 100% sulfuric acid collection efficiency.

Based upon the inlet efficiency and the particulate collection efficiency of the multiple impactors, the porous denuder system is suitable for use as a personal sampler in an environment of mixed gasses, droplets and particulates.

In order to further illustrate the advantages of the porous denuder system of the present invention, different efficiencies provided by different samplers in the same environment are presented in the following:

### Sampling Results from Waste Water Treatment Factories for the Semiconductor Industry

(a) Concentration of Acidic Aerosols Collected by the HDS

The concentrations detected by the HDS were all very low (at the ppb level); a sampling result of the HDS is shown in Table 1. Two stage honey-comb tubes of the HDS were used for collecting acidic and alkali gases. Therefore, the concentrations of acidic and alkali gases in the result were analyzed from these two stages. Furthermore, the concentration of water soluble ions was analyzed from the three stage filter paper cartridge, which includes particulates, as well as volatile acidic and alkali gases from the particulates on the Teflon filter paper.

The HF concentration range was 1.76˜5.48 ppb (with an average of 3.52±1.52 ppb); the HCl concentration range was 3.80˜11.52 ppb (with an average of 6.54±3.01 ppb); the HNO₂ concentration range was 1.05˜1.54 ppb (with an average of 1.35±0.18 ppb); the HNO₃ concentration range was 0.44˜51.58 ppb (with an average of 0.77±0.44 ppb); the SO₂ concentration range was 6.81˜13.6 ppb (with an average of 8.96±2.58 ppb); the NH₃ concentration range was 10.33˜17.0 ppb (with an average of 13.01±2.47 ppb). For particulates: the Cl⁻ concentration range was 1.53˜3.01 μg/m³ (with an average of 2.15±0.56 μg/m³); the NO₃— concentration range was 3.03˜5.01 μg/m³ (with an average of 3.60±0.78 μg/m³); the NH₄^{±} concentration range was 1.36˜1.92 μg/m³ (with an average of 1.76±0.20 μg/m³); the H⁺concentration range was 0.0111˜0.0481 μg/m³ (with an average of 0.0275±0.0136 μg/m³).

(b) Concentration of Acidic Aerosols Collected by the Porous Denuder System

The porous denuder system has results similar to those for the HDS. The first to fifth inertial impactors were used for collecting particulates, and water soluble ions were analyzed from the five stages of the inertial impactors, and from an after-filter. The two stage denuders behind the inertial impactor were used for collecting acidic and alkali gases. Therefore, the concentrations of acidic and alkali gases were analyzed from these two stages.

The sampling results of the porous denuder system are shown in Table 2: the HF concentration range was 1.81˜5.42 ppb (with an average of 3.57±1.55 ppb); the HCl concentration range was 3.71˜11.99 ppb (with an average of 6.70±3.21 ppb); the HNO₂ concentration range was 1.05˜1.58 ppb (with an average of 1.39±0.20 ppb); the HNO₃ concentration range was 0.48˜1.67 ppb (with an average of 0.78±0.47 ppb); the SO₂ concentration range was 6.46˜12.94 ppb (with an average of 8.70±2.38 ppb); the NH₃ concentration range was 10.1˜16.2 ppb (with an average of 12.7±2.13 ppb). For the particulates: the Cl⁻ concentration range was 1.48˜2.85 μg/m³ (with an average of 2.09±0.51 μg/m³); the NO₃— concentration range was 3.00˜5.08 μg/m³ (with an average of 3.65±0.80 μg/m³); the NH₄+concentration range was 1.33˜1.84 μg/m³ (with an average of 1.72±0.20 μg/m³); the H⁺ concentration range was 0.0111˜0.0485 μg/m³ (with an average of 0.0278±0.0149 μg/m³).

TABLE 1

| | HF | HCl | HNO₂ | HNO₃ | SO₂ | NH₃ | Cl⁻ | NO₃⁻ | NH₄⁺ | H⁺ | (Cl⁻ + NO₃⁻)/(NH₄⁺ + H⁺) |
|---|---|---|---|---|---|---|---|---|---|---|---|
| HDS | ppb | ppb | ppb | ppb | ppb | ppb | μg/m³ | μg/m³ | μg/m³ | μg/m³ | Molar ratio(nmol/nmol) |
| #1 | 1.76 | 11.52 | 1.32 | 1.01 | 13.60 | 13.20 | 3.01 | 3.33 | 1.80 | 0.0481 | 0.94 |
| #2 | 2.65 | 8.90 | 1.50 | 1.58 | 10.20 | 10.30 | 1.79 | 3.11 | 1.83 | 0.0111 | 0.89 |
| #3 | 2.04 | 3.80 | 1.54 | 0.45 | 7.60 | 14.52 | 1.81 | 5.01 | 1.80 | 0.0311 | 1.01 |
| #4 | 3.15 | 4.44 | 1.40 | 0.49 | 8.60 | 17.00 | 2.12 | 4.03 | 1.82 | 0.0351 | 0.92 |
| #5 | 5.04 | 5.38 | 1.05 | 0.51 | 7.10 | 12.01 | 2.62 | 3.03 | 1.92 | 0.0241 | 0.94 |
| #6 | 5.48 | 5.23 | 1.29 | 0.61 | 6.81 | 11.01 | 1.53 | 3.09 | 1.36 | 0.0154 | 1.02 |
| Average | 3.52 | 6.54 | 1.35 | 0.77 | 9.00 | 13.00 | 2.15 | 3.60 | 1.76 | 0.0275 | 0.95 |
| Standard deviation | 1.52 | 3.01 | 0.18 | 0.44 | 2.60 | 2.50 | 0.56 | 0.78 | 0.20 | 0.0136 | 0.05 |

| | | |
|---|---|---|
| #1 | #2 | #3 |

| | Cl⁻ | NO₃⁻ | NH₄⁺ | Cl⁻ | NO₃⁻ | NH₄⁺ | Cl⁻ | NO₃⁻ | NH₄⁺ |
|---|---|---|---|---|---|---|---|---|---|
| HDS | μg/m³ | μg/m³ | μg/m³ | μg/m³ | μg/m³ | μg/m³ | μg/m³ | μg/m³ | μg/m³ |
| Teflon filter | 1.50 | 1.70 | 1.00 | 1.09 | 1.60 | 1.31 | 1.10 | 2.71 | 0.90 |
| Nylon filter | 1.51 | 1.63 | *N.D. | 0.70 | 1.51 | N.D. | 0.71 | 2.30 | N.D. |
| Glass-fiber | N.D. | N.D. | 0.80 | N.D. | N.D. | 0.52 | N.D. | N.D. | 0.90 |
| filter | | | | | | | | | |

| | | |
|---|---|---|
| #4 | #5 | #6 |

| | Cl⁻ | NO₃⁻ | NH₄⁺ | Cl⁻ | NO₃⁻ | NH₄⁺ | Cl⁻ | NO₃⁻ | NH₄⁺ |
|---|---|---|---|---|---|---|---|---|---|
| HDS | μg/m³ | μg/m³ | μg/m³ | μg/m³ | μg/m³ | μg/m³ | μg/m³ | μg/m³ | μg/m³ |
| Teflon filter | 1.02 | 2.04 | 0.91 | 1.49 | 1.57 | 1.25 | 0.95 | 1.90 | 1.06 |
| Nylon filter | 1.10 | 1.99 | N.D. | 1.13 | 1.46 | N.D. | 0.58 | 1.19 | N.D. |
| Glass-fiber | N.D. | N.D. | 0.91 | N.D. | N.D. | 0.67 | N.D. | N.D. | 0.30 |
| filter | | | | | | | | | |

*N.D. = not detected

TABLE 2

| | HF | HCl | HNO₂ | HNO₃ | SO₂ | NH₃ | Cl⁻ | NO₃⁻ | NH₄⁺ | H⁺ | (Cl⁻ + NO₃⁻)/(NH₄⁺ + H⁺) |
|---|---|---|---|---|---|---|---|---|---|---|---|
| Porous denuder | ppb | ppb | ppb | ppb | ppb | ppb | μg/m³ | μg/m³ | μg/m³ | μg/m³ | Molar ratio (nmol/nmol) |
| #1 | 1.81 | 11.99 | 1.38 | 0.98 | 12.94 | 12.7 | 2.85 | 3.22 | 1.75 | 0.0485 | 0.91 |
| #2 | 3.83 | 9.22 | 1.56 | 1.68 | 9.90 | 10.1 | 1.86 | 3.29 | 1.80 | 0.0145 | 0.92 |
| #3 | 1.98 | 3.71 | 1.58 | 0.47 | 7.32 | 13.9 | 1.76 | 5.08 | 1.76 | 0.0412 | 0.95 |
| #4 | 3.13 | 4.53 | 1.48 | 0.52 | 8.24 | 16.2 | 2.02 | 4.12 | 1.84 | 0.0302 | 0.93 |
| #5 | 5.23 | 5.68 | 1.05 | 0.48 | 7.36 | 12.3 | 2.54 | 3.17 | 1.86 | 0.0212 | 0.99 |
| #6 | 5.42 | 5.10 | 1.31 | 0.58 | 6.46 | 11.2 | 1.48 | 3.00 | 1.33 | 0.0111 | 1.06 |
| Average | 3.57 | 6.70 | 1.39 | 0.78 | 8.70 | 12.7 | 2.09 | 3.65 | 1.72 | 0.0278 | 0.96 |
| Standard deviation | 1.55 | 3.21 | 0.20 | 0.47 | 2.38 | 2.13 | 0.51 | 0.80 | 0.20 | 0.0149 | 0.06 |

| | | |
|---|---|---|
| #1 | #2 | #3 |

| Porous | Cl⁻ | NO₃⁻ | NH₄⁺ | Cl⁻ | NO₃⁻ | NH₄⁺ | Cl⁻ | NO₃⁻ | NH₄⁺ |
|---|---|---|---|---|---|---|---|---|---|
| denuder | μg/m³ | μg/m³ | μg/m³ | μg/m³ | μg/m³ | μg/m³ | μg/m³ | μg/m³ | μg/m³ |
| 1st Impactor | *N.D. | N.D. | N.D. | N.D. | N.D. | N.D. | N.D. | N.D. | N.D. |
| 2nd Impactor | N.D. | N.D. | N.D. | N.D. | N.D. | N.D. | N.D. | N.D. | N.D. |
| 3rd Impactor | N.D. | N.D. | N.D. | N.D. | N.D. | N.D. | N.D. | N.D. | N.D. |
| 4th Impactor | N.D. | N.D. | N.D. | N.D. | N.D. | N.D. | N.D. | N.D. | N.D. |
| 5th Impactor | N.D. | N.D. | N.D. | N.D. | N.D. | N.D. | N.D. | N.D. | N.D. |
| after-filter | 2.85 | 3.22 | 1.75 | 1.86 | 3.29 | 1.80 | 1.76 | 5.08 | 1.76 |

| | | |
|---|---|---|
| #4 | #5 | #6 |

| Porous | Cl⁻ | NO₃⁻ | NH₄⁺ | Cl⁻ | NO₃⁻ | NH₄⁺ | Cl⁻ | NO₃⁻ | NH₄⁺ |
|---|---|---|---|---|---|---|---|---|---|
| denuder | μg/m³ | μg/m³ | μg/m³ | μg/m³ | μg/m³ | μg/m³ | μg/m³ | μg/m³ | μg/m³ |
| 1st Impactor | N.D. | N.D. | N.D. | N.D. | N.D. | N.D. | N.D. | N.D. | N.D. |
| 2nd Impactor | N.D. | N.D. | N.D. | N.D. | N.D. | N.D. | N.D. | N.D. | N.D. |
| 3rd Impactor | N.D. | N.D. | N.D. | N.D. | N.D. | N.D. | N.D. | N.D. | N.D. |
| 4th Impactor | N.D. | N.D. | N.D. | N.D. | N.D. | N.D. | N.D. | N.D. | N.D. |
| 5th Impactor | N.D. | N.D. | N.D. | N.D. | N.D. | N.D. | N.D. | N.D. | N.D. |
| after-filter | 2.02 | 4.12 | 1.84 | 2.54 | 3.17 | 1.86 | 1.48 | 3.00 | 1.33 |

*N.D. = not detected

TABLE 3

| | HF | HCl | HNO₂ | HNO₃ | SO₂ |
|---|---|---|---|---|---|
| Silica gel tube | ppb | ppb | ppb | ppb | ppb |
| #1 | 1.88 | 11.31 | 1.36 | 1.00 | 12.94 |
| #2 | 3.70 | 8.95 | 1.60 | 1.61 | 10.05 |
| #3 | 1.89 | 3.96 | 1.51 | 0.50 | 7.10 |
| #4 | 3.03 | 4.33 | 1.53 | 0.49 | 8.30 |
| #5 | 5.06 | 5.36 | 1.08 | 0.45 | 7.40 |
| #6 | 5.12 | 5.33 | 1.35 | 0.62 | 6.90 |
| Average | 3.45 | 6.54 | 1.41 | 0.78 | 8.80 |
| Standard deviation | 1.45 | 2.93 | 0.19 | 0.45 | 2.40 |

| | HF | | | | HCl | | | | HNO₂ | | | |
|---|---|---|---|---|---|---|---|---|---|---|---|---|
| | ppb | | | | ppb | | | | ppb | | | |
| Silica gel tube | Total | Section 1 | Section 2 | Section 3 | Total | Section 1 | Section 2 | Section 3 | Total | Section 1 | Section 2 | Section 3 |
| #1 | 1.88 | *N.D. | 1.88 | N.D. | 11.31 | N.D. | 11.31 | N.D. | 1.36 | N.D. | 1.36 | N.D. |
| #2 | 3.70 | N.D. | 3.70 | N.D. | 8.95 | N.D. | 8.95 | N.D. | 1.60 | N.D. | 1.60 | N.D. |
| #3 | 1.89 | N.D. | 1.89 | N.D. | 3.96 | N.D. | 3.96 | N.D. | 1.51 | N.D. | 1.51 | N.D. |
| #4 | 3.03 | N.D. | 3.03 | N.D. | 4.33 | N.D. | 4.33 | N.D. | 1.53 | N.D. | 1.53 | N.D. |
| #5 | 5.06 | N.D. | 5.06 | N.D. | 5.36 | N.D. | 5.36 | N.D. | 1.08 | N.D. | 1.08 | N.D. |
| #6 | 5.12 | N.D. | 5.12 | N.D. | 5.33 | N.D. | 5.33 | N.D. | 1.35 | N.D. | 1.35 | N.D. |

| | HNO₃ | | | | SO₂ | | | |
|---|---|---|---|---|---|---|---|---|
| | ppb | | | | ppb | | | |
| Silica gel tube | Total | Section 1 | Section 2 | Section 3 | Total | Section 1 | Section 2 | Section 3 |
| #1 | 1.00 | N.D. | 1.00 | N.D. | 12.94 | N.D. | 12.94 | N.D. |
| #2 | 1.61 | N.D. | 1.61 | N.D. | 10.05 | N.D. | 10.05 | N.D. |
| #3 | 0.50 | N.D. | 0.50 | N.D. | 7.10 | N.D. | 7.10 | N.D. |
| #4 | 0.49 | N.D. | 0.49 | N.D. | 8.30 | N.D. | 8.30 | N.D. |
| #5 | 0.45 | N.D. | 0.45 | N.D. | 7.40 | N.D. | 7.40 | N.D. |
| #6 | 0.62 | N.D. | 0.62 | N.D. | 6.90 | N.D. | 6.90 | N.D. |

Section 1: glass fiber and PVC filter paper
before 400 mg silica gel
Section 2: 400 mg silica gel
Section 3: 200 mg silica gel
*N.D. = not detected

(c) Concentration of Acidic Aerosols Collected by a Silica Gel Tube

In this experiment, a background concentration of the silica gel tube was subtracted from the results. The results of the silica gel tube are shown in Table 3, wherein all acidic gases are mainly absorbed at a second section (400 mg) silica gel tube. The HF concentration range was 1.88˜5.12 ppb (with an average of 3.45±1.45 ppb); the HCl concentration range was 3.96˜11.31 ppb (with an average of 6.54±2.93 ppb); the HNO₂ concentration range was 1.08˜1.60 ppb (with an average of 1.41±0.19 ppb); the HNO₃ concentration range was 0.45˜1.61 ppb (with an average of 0.78±0.45 ppb); the SO₂ concentration range was 6.90˜12.9 ppb (with an average of 8.80±2.40 ppb).

(d) Concentration of Acidic Aerosols Collected by a Filter Paper Cartridge

Samples collected by the filter paper cartridge were particulates, and the results are shown in Table 4: the Cl⁻ concentration range was 1.55˜3.02 μg/m³ (with an average of 2.17±0.55 μg/m³); the NO₃— concentration range was 3.12˜5.01 μg/m³ (with an average of 3.65±0.74 μg/m³); the NH₄⁺ concentration range was 1.30˜1.88 μg/m³ (with an average of 1.73±0.22 μg/m³); the ±concentration range was 0.0122˜0.0449 μg/m³ (with an average of 0.0282±0.0128 μg/m³).

TABLE 4

| | | | | | (Cl⁻ + NO₃⁻)/ |
|---|---|---|---|---|---|
| Filter | | | | | (NH₄⁺ + H⁺) |
| paper | Cl⁻ | NO₃⁻ | NH₄⁺ | H⁺ | Molar ratio |
| cartridge | μg/m³ | μg/m³ | μg/m³ | μg/m³ | (nmol/nmol) |
| #1 | 3.02 | 3.30 | 1.80 | 0.0479 | 0.94 |
| #2 | 1.88 | 3.22 | 1.82 | 0.0122 | 0.93 |
| #3 | 1.76 | 5.01 | 1.72 | 0.0320 | 1.03 |
| #4 | 2.14 | 4.02 | 1.88 | 0.0341 | 0.90 |
| #5 | 2.61 | 3.25 | 1.84 | 0.0254 | 0.99 |
| #6 | 1.55 | 3.12 | 1.30 | 0.0174 | 1.05 |
| Average | 2.17 | 3.65 | 1.73 | 0.0282 | 0.97 |
| Standard | 0.55 | 0.74 | 0.22 | 0.0128 | 0.06 |
| deviation | | | | | |

(e) Comparing Each Sampler

FIG. 6 and FIG. 7 respectively show HF gas comparison results between the porous denuder system and the HDS and the silica gel tube. As shown in the drawings, the porous denuder system and the HDS have very similar results; a related coefficient R² is 0.995, and a related error does not exceed 3.76%. A related error between the porous denuder system and the silica gel tube is 5.86%, and a related coefficient R² is 0.998. FIG. 8 and FIG. 9 show a sampling result of HCl gas; the porous denuder system has a related error of 5.587% and 6.29%, and a related coefficient R² of 0.998 and 0.995 respectively with the HDS and the silica gel tube. The results show that these three samplers detected similar acidic gas concentrations, and all have a related coefficient R² that exceeds 0.995. When the sample number of each sampler is 6, the results of a single factor variable analysis for the porous denuder system, the HDS and the silica gel tube are similar (with a P value >0.05).

In the sampling results for HF and HCl gas, a concentration standard deviation detected from each sampler is larger than for other gases, and the main reason for this is that during a waste HF acid liquid treatment, the samplers add HCl to balance the pH value. The sampler uses CaCl₂ as coagulant to react with F⁻ ions to create CaF₂, a stable material to reach waste water standards. Therefore, every sampling process detects different HF and HCl gas concentrations.

Furthermore, for acidic gases, such as HNO₂, HNO₃, SO₂ (as shown in FIG. 10 to FIG. 15), and the alkali gas NH₃ (as shown in FIG. 22), the porous denuder system has a related error under 6.11% and a related coefficient R² above 0.94, respectively, with both the HDS and the silica gel tube. Since the sampling environment is an open air environment, the results of other acidic and alkali gas samples are similar to the atmospheric sampling, which indicates that there is no additional acidic and alkali gas pollution, and little gaseous HF and HCl (greater than normal atmospheric concentrations), but both of the two concentrations are in a PEL range (HF and HCl's PEL values are respectively 3 ppm and 5 ppm). Furthermore, the silica gel tube can be used for the sampling of an acidic gas with a low ppb. As in the above description, in this experiment, the background concentration of the silica gel tube was taken previously; if not, the results from the silica gel tube may be over-estimated. Taking HNO₃ with the highest background concentration as an example, in a 10 ml extracted liquid volume, a background concentration was 0.081 ppm, which can be converted to 0.5 lpm, a background concentration of HNO₂ for 8 hours is 1.33 ppb, which is about 170% positive error.

For particulate materials, such as Cl⁻, NO₃⁻, NH₄⁺, the sampling results of the porous denuder system, the HDS and the filter paper cartridge (as shown in FIGS. 16˜21) show that the concentrations of three samplers are very close, with related coefficients R² all above 0.974, and related errors under 5.79%. Moreover, when a sample number of every sampler is 6, the results of single factor variable analysis for the porous denuder system, the HDS and the filter paper cartridge are similar (with a P value >0.05). For concentrations of particulate H⁺, the sampling concentrations of the porous denuder system, the HDS and the filter paper cartridge were 0.0278, 0.0275 and 0.0282 μg/m³, which are much lower than the H⁺concentrations in vapor pollution.

Finally, regarding anion and cation balancing of particulate materials, in four C₁, NO₃⁻, NH₄⁺ and H⁺ water resoluble ions, a nmol ratio value of (Cl⁻+NO₃⁻)/(NH₄⁺+H⁺) in the HDS has an average of 0.95±0.05; a nmol ratio value of (Cl⁻+NO₃⁻)/(NH₄⁺+H⁺) in the porous denuder system has an average of 0.96±0.06; and the nmol ratio value of (Cl⁻+NO₃)/(NH₄⁺±H⁺) in the filter paper cartridge has an average of 0.97±0.06, which indicates that there is no other ion interference. In the above results, the H⁺ ion has a low concentration, and the Cl⁻, NO₃ ions are neutralized by the NH₄⁺ ions. A neutralization efficiency for the porous denuder system, the HDS and the filter paper cartridge respectively are 82.0±7.8%, 83.1±10.2% and 80.5±9.0%, which indicates that most of the particlates are neutral ammonium chloride or compound of ammonium nitrate, and most of the acidic aerosols are neutralized by NH₃.

Accordingly, the porous denuder system is suitable for mixing acidic and alkali gases having low concentrations, and particulate field sampling. When the sampling time is long enough, even if every specie has a low concentration, the porous denuder system can collect different species (gas, droplets and particulates); for example in the telecommunication exchange room of a telephone company. However, the prior art sampler can not cover both sampling for acidic and alkali gases and droplets; the silica gel tube can only sample the acidic gases; the HDS can only sample acidic and alkali gases with low concentrations, not particulates larger than 2.5 μm; the filter paper cartridge can only sample aerosols with fine particulates, but is not able to indicate the gas concentration distributions in the field. Marple personal multiple impactors can only sample field particulates and indicate the particulate distribution, but not the gas concentration distribution. According to the above-mentioned comparison, the porous denuder system can sample acidic and alkali gases and particulates. In actual field sampling, the porous denuder system can also utilize a one stage impactor to collect particulate material; a two stage porous metal sheet is coated with proper solutions to absorb acidic and alkali gases. Therefore, the porous denuder system has a smaller volume, which is easier for personal field sampling; and if it is necessary to obtain a diameter distribution of field droplets, the five stage impactor can be utilized for sampling.

Although the present invention has been explained in relation to its preferred embodiment, it is to be understood that many other possible modifications and variations can be made without departing from the spirit and scope of the invention as hereinafter claimed.

What is claimed is:

1. A porous denuder system comprising:
a sample inlet, which is a hollow tube and has a first connecting element at an external top end;
a particle sorter comprising one or a plurality of annular sorters, the sorter located in the sample inlet and one end of the sorter being pushing against an inside of the top end of the sample inlet;
a porous collecting element made of a porous material; and
a sampling body, which is a hollow tube and has a first connecting element at a top end outside for connecting to the first connecting element at the sample inlet external top end, and a stopper at a bottom end for pushing against the porous absorbing element so the porous absorbing elemnent is placed between the particle sorter and the stopper, and the stopper has a through hole or a through tube at a center for connecting to an external part.

2. The porous denuder system as claimed in claim 1, wherein the particle sorter comprises a plurality of annular sorters.

3. The porous denuder system as claimed in claim 2, wherein the particle sorter comprises two to six annular sorters.

4. The porous denuder system as claimed in claim 3, wherein the particle sorter comprises three to five annular sorters.

5. The porous denuder system as claimed in claim 1, wherein the particle sorter is an inertial impactor.

6. The porous denuder system as claimed in claim 2, wherein the particle sorter is an inertial impactor.

7. The porous denuder system as claimed in claim 3, wherein the particle sorter is an inertial impactor.

8. The porous denuder system as claimed in claim 4, wherein the particle sorter is an inertial impactor.

9. The porous denuder system as claimed in claim 1, wherein the porous collecting element is combined with a denuder.

10. The porous denuder system as claimed in claim 2, wherein the porous collecting element is combined with a denuder.

11. The porous denuder system as claimed in claim 3, wherein the porous collecting element is combined with a denuder.

12. The porous denuder system as claimed in claim 4, wherein the porous collecting element is combined with a denuder.

13. The porous denuder system as claimed in claim 5, wherein the porous collecting element is combined with a denuder.
